(19) United States
(12) Patent Application Publication
(10) Pub. No.: US 2008/0010323 A1
(43) Pub. Date: Jan. 10, 2008

(54) Method for duplicating data

(75) Inventors: Sung-Jung Wang, Taipei County (TW); Tai-Ching Chiu, Taipei County (TW); Shih-Chiang Tsao, Hsinchu City (TW)

Correspondence Address: BIRCH STEWART KOLASCH & BIRCH, PO BOX 747, FALLS CHURCH, VA, 22040-0747, US

(73) Assignee: AN CHEN COMPUTER CO., LTD.

(21) Appl. No.: 11/481,049

(22) Filed: Jul. 6, 2006

(51) Int. Cl. G06F 17/30

(52) U.S. Cl. 707/204

(57) ABSTRACT

A method for duplicating data of a source medium to target media includes the steps of: analyzing the file table (FAT, BITMAP . . . ) of the source medium to find addresses. Establishing a duplicating table, in which the addresses of the source medium stored with data are stored and ranked. Copying data of the source medium to the target media according to the content of duplicating table, wherein a copying order is in accordance with an order of the addresses rather than the files.

### BACKGROUND OF THE INVENTION

1. Field of the Invention

The present invention relates generally to a computer peripheral device, and more particular to a method for duplicating data from a source data medium to a plurality of target media in a fast and reliable way.

2. Description of the Related Art

A simple and fast way of duplication is cloning the source medium to another medium. For a read-only media, there will not be the issue of writing datum, so that such media have the data gathering up to have all data effective for duplication.

There are random-access medium, which may read and write data, having empty regions for the data written therein latterly, so that a file may be divided into several fragments and stored in different regions of the medium. The random-access medium usually has a manage space and a data space, wherein the manage space stores the information of operating system and file system, such as partition table, active program, file allocation table (FAT) etc., and the data space stores the data of the files therein. FAT is a table recording the contents of the data in the data space, including names of the files, addresses of the data, such as cluster addresses, for the index of the files.

To duplicate a source random-access medium to another target random-access medium, the data of the manage space of the source random-access medium are copied first, and then system will read the content of FAT to copy the files in the data space in a way of file by file. As a result, the read/write heads of the source and target media reciprocate between the FAT in the manage space and the fragments of files in the data space repeatedly that slows the speed of duplication much when the files have a large number of fragments and the fragments are not centralized.

### SUMMARY OF THE INVENTION

The primary objective of the present invention is to provide a method of duplicating data, which may reduce the moving time of the read/write head of the media to short the duplication time.

According to the objective of the present invention, a method for duplicating data of a source medium to at least one target medium includes the steps of: analyzing the source medium to find addresses of the source medium stored with data and recording the addresses in a duplicating table and ranking the addresses of the duplicating table, and then copying data of the source medium to the at least one target medium according to the addresses of duplicating table in sequence, wherein a copying order is in accordance with an order of the addresses of the duplicating table.

### BRIEF DESCRIPTION OF THE DRAWINGS

FIG. 1 is a sketch diagram of the duplication system of a preferred embodiment of the present invention; and

FIG. 2 is a flow chart of the duplication system of the preferred embodiment of the present invention.

### DETAILED DESCRIPTION OF THE INVENTION

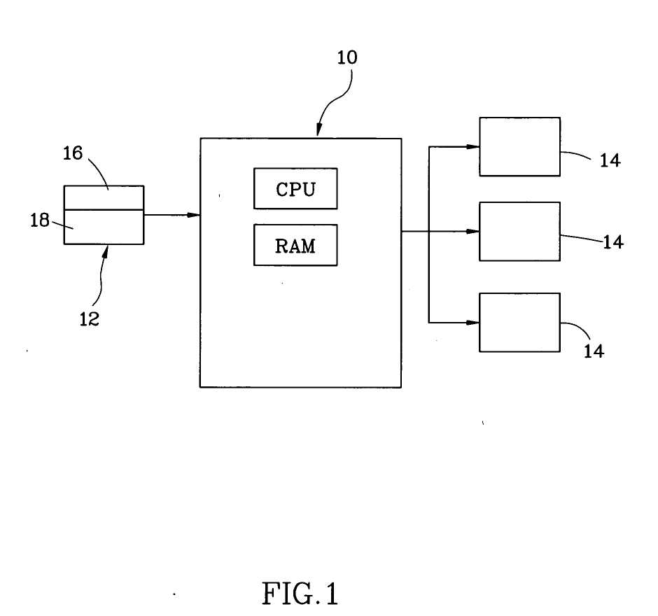

As shown in FIG. 1, a duplication system utilizing the method of the present invention includes a duplicator 10, a source medium 12 and a plurality of target media 14. The duplicator 10 has a CPU, RAM, and other relative devices, such as switches, multiplexer, buffer etc., to copy the data in the source medium 12 to the target media 14. The source and target media 12, 14 are random-access mass storage devices, such as floppy disks, hard disks, compact disks (CD), digital video disks (DVD), flash memory devices, tapes and other relative devices and combination of above.

The source medium 12 includes a mange space 16 and a data space 18, wherein the mange space 16 stores a partition table, an active program, a file table, and son on. The data space 18 stores at least a file, which may be data file, execution file, video file, audio file, and so on. The file table is the file allocation table (FAT) in the Windows® system or other relative tables in different operating systems, in which names of files and addresses of fragments of the files in the data space 18. The file system of the source medium 12 is as same as the common storage media.

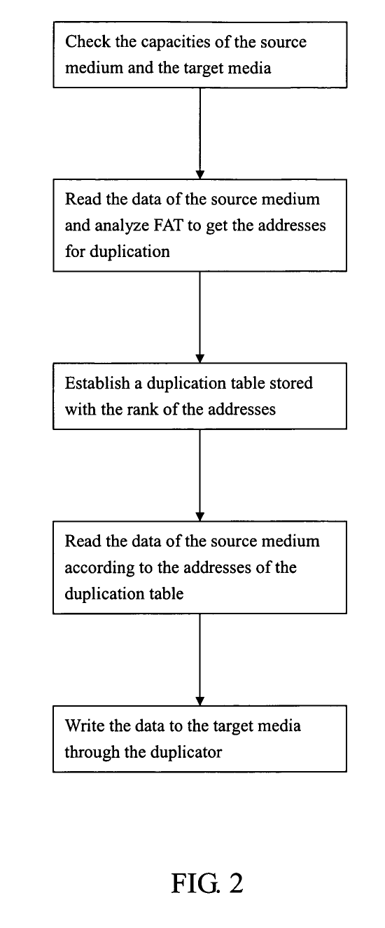

As shown in FIG. 2, the duplicator 10 checks whether the storage capacities of the source and target media 12, 14 are the same first? If do, then perform the steps hereunder:

First, reading the data in the manage space 16 of the source medium 12, and analyzing the file table. The analyzing result is recorded in a duplication table and stored in the memory of the duplicator 10. The content of the duplication table includes addresses of clusters of the fragments of files in the manage space 16 and data space 18, and ranking the addresses in an order of clusters.

Basically, the file table indicates the contribution of the files in the medium. The file table has different names in different operating system, such as FAT 12/16/32 in DOS system, BITMAP in NEFS system . . . , and has different contents in different operating system. Some of them list the used or not-used clusters, some of them list the corresponding files and the used clusters, and some of them only list the used or not-used clusters. No matter or what kinds of the file tables, we can analyze the content of the file table to get the clusters of the source media 12 for duplication.

Next, reading the data of the source media 12 according to the file table and copying them to the target media 14 at the corresponding addresses in sequence.

According to the method of the present invention, the duplication is in an order of clusters instead of files. The read/write heads of the source and target media 12, 14 utilizing the method of the present invention move from the first cluster to the last cluster of the media in sequence rather than jump between the file table in the manage space and the fragments in the data space of the conventional duplication system that shorts the duplicating time much.

Another character of the method of the present invention is that it doesn't need to formalize the target media prior to duplication, the format process is done in the duplication. The file table is stored in the memory of the duplicator, so that the file table is utilized in the next time duplication of the same source medium.

It is preferred that the source medium 12 and the target media 14 have the same storage capacity for the duplicating method of the present invention. It is required to check whether the storage capacity of the source medium 12 and the target media 14 are the same, if do, then the method of the present invention may perform functionally. If the storage capacity of the source medium 12 and the target media 14 are different, the method of the present invention has to make some adjustment before performing.

In addition, in duplication of data, a duplicating order may copy a continuous fragment of data. If the fragments of data are short and discontinuous, ever duplicating order only copies a short datum, in other words, the bandwidth is occupied by the duplicating orders rather than the duplicating data. To overcome the problem above, we can calculate a suitable duplicating section, which may be two clusters to hundreds of clusters, for duplication. In the duplicating section, there may be invalid data copied, but the times of duplicating orders are reduced that may shorten the time of duplication. This process is powerful when the effective data of the medium are discontinuous and short.

What is claimed is:

1. A method for duplicating data of a source medium to at least one target medium, wherein the source medium includes a data space, in which at least one file is stored, and a manage space, in which a file table is stored to indicate addresses of storing or not storing fragments of the at least one file, comprising the steps of:
analyzing the source medium to find addresses of the source medium stored with data and recording the addresses in a duplicating table;
ranking the addresses of the duplicating table; and
copying data of the source medium to the at least one target medium according to the addresses of duplicating table in sequence, wherein a copying order is in accordance with an order of the addresses of the duplicating table.

2. The method as defined in claim 1, wherein the steps of analyzing the source medium comprising reading data of the file table in the manage space to find the addresses of the source medium stored with data.

3. The method as defined in claim 1, wherein the step of copying the data of the source medium copies the data of a plurality of continuous clusters for a time of copying.
